(19) United States
(12) Patent Application Publication
(10) Pub. No.: US 2024/0417635 A1
(43) Pub. Date: Dec. 19, 2024

(54) A METHOD FOR PRODUCING RENEWABLE AVIATION FUEL

(71) Applicant: NESTE OYJ, Espoo (FI)

(72) Inventors: Sylvia ALBERSBERGER, Porvoo (FI); Eveliina MÄKELÄ, Porvoo (FI); Marja TIITTA, Porvoo (FI)

(21) Appl. No.: 18/724,020

(22) PCT Filed: Nov. 21, 2022
(86) PCT No.: PCT/FI2022/050769

§ 371 Date: Jun. 25, 2024

(30) Foreign Application Priority Data
Dec. 27, 2021 (FI) 20216359

(51) Int. Cl. C10L 1/06

(52) U.S. Cl. CPC C10L 1/06; C10L 2200/0484; C10L 2270/04

(57) ABSTRACT

The present invention relates to a method for producing renewable aviation fuel D or components thereto from renewable feedstock A comprising separate hydrodeoxygenation (20) hydroisomerization step (40), wherein the hydroisomerization is catalysed by metal impregnated hierarchical zeolite catalyst.

### FIELD

The present invention relates to a method for producing renewable aviation fuel or components thereto from renewable feedstock, in particular to methods comprising hydrodeoxygenation and hydroisomerization steps wherein the hydroisomerization is catalysed by metal impregnated hierarchical zeolite catalyst.

### BACKGROUND

Aviation has been reported to account for 2.4% of the global CO₂ emissions in 2019 with an increase to about 4.3% by 2050. Several countries have introduced mandates to blend sustainable aviation fuel (SAF) with fossil aviation fuel. For example, Finland has proposed to aim for up to 30% blends by 2030.

Renewable aviation fuel demand is expected to grow in the future due to global initiatives to decrease emissions of greenhouse gases. One possibility to decrease greenhouse gas emissions is to increase the use of renewable fuels in preparation of aviation fuels. Renewable aviation fuel derived from biomass, such as plants, trees, algae, waste, and other organic matter bio-oils, offers an opportunity to reduce these emissions.

There are different types of aviation fuels which are strictly specified in various standards. Aircraft and engine fuel system components and fuel control units rely on the fuel to lubricate their moving parts. For example, lubricity of aviation kerosene type fuel produced by hydroprocessing is limited by the DEF STAN 91-091 standard to a maximum wear scar diameter of 0.85 mm as measured with an ASTM D5001 and ASTM D7566-19 test methods called BOCLE (ball on cylinder lubricity evaluator). The requirement to measure lubricity is applied whenever synthesized fuel components are used in a final fuel blend. Fuel lubricity is important especially in military use.

The hydrocarbon isomer distribution in petrochemicals contributes to many important petrochemical characteristics such as boiling and melting points, octane number, combustion efficiency, flash point, viscosity, lubricity, solubility, and solvation power. These characteristics are strongly influenced by hydrocarbon chain branching. This is especially important for aviation turbine fuels. If these are not to specification, aviation fuel lines can freeze up or give rise to engine malfunction.

Accordingly, there is a need for further methods for producing renewable aviation fuel.

### SUMMARY

The present invention is based on the observation that when a feedstock of biological origin is hydrodeoxygenated followed by hydroisomerization using certain hierarchical zeolites of medium mesoporosity as catalyst, branching of the isomerized products is significantly increased compared to the corresponding non-hierarchical zeolites. This in turn, allows preparation of renewable aviation fuel of enhanced properties.

Accordingly, it is an object of the present invention to provide a method for producing renewable aviation fuel or a component thereto from a feedstock of biological origin, the method comprising:
a) providing the renewable feedstock,
b) pre-treating the renewable feedstock by reducing the amount of impurities therein not to include: more than 10 w-ppm alkali metal and alkaline earth metal impurities, calculated as elemental alkaline metals and alkaline earth metals; more than 10 w-ppm other metals, calculated as elemental metals; more than 1000 w-ppm nitrogen containing impurities, calculated as elemental nitrogen; more than 30 w-ppm phosphorus containing impurities, calculated as elemental phosphorus; more than 5 w-ppm silicon containing impurities, calculated as elemental silicon; to produce a pre-treated feedstock,
c) subjecting the pre-treated feedstock to hydrodeoxygenation reaction to produce a hydrodeoxygenated stream, wherein the hydrodeoxygenation reaction conditions comprise one or more of:
   i) a temperature in the range from 250° C. to 400° C.,
   ii) a pressure in the range from 10 bar to 200 bar,
   iii) a WHSV in the range from 0.5 h⁻¹ to 3 h⁻¹,
   iv) a H₂ flow from 350 to 1500 N-L H₂/L feed, and
v) a hydrodeoxygenation catalyst selected from Pd, Pt, Ni, Co, Mo, Ru, Rh, and W or any combination thereof, on a support,
   to produce a hydrodeoxygenated stream,
d) subjecting the hydrodeoxygenated stream to a gas-liquid separation to produce a gaseous stream and a hydrodeoxygenated liquid stream,
e) subjecting the hydrodeoxygenated liquid stream to hydroisomerization reaction, in the presence of a metal impregnated hierarchical ZSM-23 catalyst, wherein the metal is selected from platinum, palladium, nickel, and iridium and any combinations thereof at a temperature from 250° C. to 340° C., and in the presence of added hydrogen, to produce a hydroisomerized stream,
f) optionally subjecting the hydroisomerized stream to stabilization to produce a stabilized hydroisomerized stream, and
g) separating the renewable aviation fuel or components thereto from the hydroisomerized stream, or from the stabilized hydroisomerized stream, wherein the renewable aviation fuel or components thereto comprises C5-C9 hydrocarbons suitable for aviation gasoline or components thereto, and C10-C18 hydrocarbons, preferably C10-C16 hydrocarbons suitable for jet fuel or components thereto.

It is also an object of the present invention to provide a use of a metal impregnated hierarchical ZSM-23 catalyst, wherein the metal is selected from platinum, palladium, nickel, and iridium and any combinations thereof, for producing renewable aviation fuel or a components thereto from a renewable paraffinic feed by hydroisomerization at a temperature from 250° C. to 340° C., and in the presence of hydrogen flow.

A number of exemplifying and non-limiting embodiments of the invention are described in accompanied dependent claims.

Various exemplifying and non-limiting embodiments of the invention together with additional objects and advantages thereof, will be best understood from the following description of specific exemplifying and non-limiting embodiments when read in connection with the accompanying FIGURES.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e., a singular form, throughout this document does not exclude a plurality.

### BRIEF DESCRIPTION OF DRAWINGS

FIG. 1 shows an exemplary non-limiting schematic overview of production of renewable aviation fuel according to an embodiment of the method of the present invention.

### DETAILED DESCRIPTION

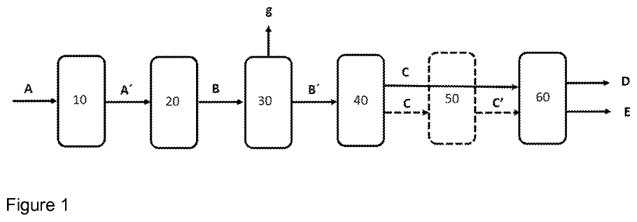

FIG. 1 shows an exemplary process of the present invention for production of renewable aviation fuel or a component thereto. In the FIGURE reference numbers and arrows illustrate reactions and streams, respectively.

According to one embodiment method comprises the following steps:
a) providing a renewable feedstock A,
b) subjecting the feedstock to a pre-treatment step 10 to produce a pre-treated feedstock A′,
c) subjecting the pre-treated feedstock to hydrodeoxygenation 20 reaction to produce hydrodeoxygenated stream B,
d) subjecting the hydrodeoxygenated stream to a gas-liquid separation to produce a gaseous stream g and a hydrodeoxygenated liquid stream B′,
e) subjecting the hydrodeoxygenated liquid stream to hydroisomerization 40 reaction to produce a hydroisomerized stream C,
f) optionally, subjecting the hydroisomerized stream to stabilization 50 to produce stabilized hydroisomerized stream C′, and
g) separating 60 from the hydroisomerized stream or from the optional stabilized hydroisomerized stream, at least the renewable aviation fuel D or components thereto, and optionally also renewable C1-C4 hydrocarbons E.

### The Feedstock

A process for preparing hydrocarbons from an oxygenated renewable hydrocarbon feedstock is disclosed. Examples of oxygenated hydrocarbon feedstocks are fatty acids and triglycerides, which are present in large amounts in e.g. plant oils and animal fats. An oxygenated hydrocarbon feedstock of renewable origin, such as plant oils and animal fats, is well suited for the process. The majority of these plant oils and animal fats are typically composed of fatty acids, either as free fatty acids or as esters of free fatty acids, such as fatty acids of 25 wt-% (weight percent) or 40 wt-% or more. Examples of esters of free fatty acids are fatty acid glyceride esters (mono-, di- and/or tri-glyceridic) or for example the fatty acid methyl esters (FAME) or fatty acid ethyl esters (FAE). Accordingly, the oxygenated hydrocarbon feedstocks of renewable origin may contain 25 wt-% or more of fatty acids or fatty acid esters.

The renewable character of carbon-containing compositions, such as feedstocks and products of biological origin i.e. renewable feedstock and products, can be determined by comparing the ¹⁴C-isotope content of the feedstock to the ¹⁴C-isotope content in the air in 1950. The ¹⁴C-isotope content can be used as evidence of the renewable origin of the feedstock or product. Carbon atoms of renewable material comprise a higher number of unstable radiocarbon (¹⁴C) atoms compared to carbon atoms of fossil origin. Therefore, it is possible to distinguish between carbon compounds derived from biological sources, and carbon compounds derived from fossil sources by analysing the ratio of ¹²C and ¹⁴C isotopes. Thus, a particular ratio of said isotopes can be used to identify and quantify renewable carbon compounds and differentiate those from non-renewable i.e. fossil carbon compounds. The isotope ratio does not change in the course of chemical reactions. Examples of a suitable method for analysing the content of carbon from biological sources is ASTM 25 D6866 (2020). An example of how to apply ASTM D6866 to determine the renewable content in fuels is provided in the article of Dijs et al., Radiocarbon, 48 (3), 2006, pp 315-323. For the purpose of the present invention, a carbon-containing material, such as a feedstock or product is considered to be of renewable origin if it contains 90% or more modern carbon, such as 100% modern carbon, as measured using ASTM D6866.

The feedstock may include animal and fish oils/fats, plant oils and/or vegetable oils and/or microbial oils like babassu oil, palm seed oil, carinata oil, olive oil, coconut butter, soybean oil, canola oil, coconut oil, muscat butter oil, rapeseed oil, peanut oil, sesame oil, maize oil, sunflower oil, poppy seed oil, cottonseed oil, soy oil, laurel seed oil, crude tall oil, tall oil, tall oil fatty acid, tall oil pitch, crude palm oil, palm oil, palm oil fatty acid distillate, jatropha oil, palm kernel oil, camelina oil, archaeal oil, bacterial oil, fungal oil, protozoal oil, algal oil, muscat butter oil, seaweed oil, mustard seed oil, oils from halophiles, lauric-myristic acid group (C12-C14) including milk fats, palmitic acid group (C16) including earth animal fats, stearic acid group (C18) including earth animal fats, linoleic acid group (unsaturated C18) including whale and fish oils, erucic acid group (unsaturated C22) including whale and fish oils, oleo stearic acid group (conjugated unsaturated C18) including whale and fish oils, fats with substituted fatty acids (ricin oleic acid, C18) such as castor oil, oils obtained from plants by gene manipulation, and mixtures of any two or more thereof.

The oils of the feedstock may be classified as crude, degummed, heat treated and RBD (refined, bleached, and deodorized) grade, depending on the level of pre-treatment and residual phosphorus and metals content.

Animal fats and/or oils may include inedible tallow, edible tallow, technical tallow, floatation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof.

The feedstock may include derivatives of natural fats including mono- or diglycerides of C10-C28 fatty acids, C10-C28 fatty acids, C10-C28 fatty acid anhydrides, non-glyceride C10-C28 fatty acid esters, C10-C28 fatty alcohols, C10-C28 fatty aldehydes and C10-C28 fatty ketones. The C10-C28 fatty acids, their mono- and diglycerides, are typically prepared by hydrolysis of the corresponding triglyceride. The non-glyceride C10-C28 fatty acid esters are mainly prepared from the triglycerides by transesterification. The C10-C28 fatty alcohols, aldehydes and ketones are prepared by reduction, usually by hydrogenation, of the corresponding fatty acids. Advantageously, the feedstock hydrocarbons may be of C10-C24.

The derivatives of natural fats also include any of the aforementioned natural fats and derivatives, the hydrocarbon chain of which has been modified e.g. by substitution, branching or saturation.

According to a particular embodiment the feedstock is selected from waste and residues from animal fat or oil, plant fat or oil, and fish fat or oil, and mixtures thereof.

An exemplary feedstock comprises at least triglycerides. Most typical exemplary feedstocks are animal fats and palm oil fatty acid, especially those originating from waste and residues.

A further exemplary feedstock comprises at least fatty acids. Most typical feedstock are various plant oils, and e.g. tall oil materials, such as crude tall oil.

The natural fats or derivatives thereof may be provided in pure form or as part of a feedstock containing other components. Preferably, the feedstock contains at least 20 wt-%, more preferably at least 30 wt-%, most preferably at least 40 wt-%, of pure natural fat or natural oil or their derivatives.

An exemplary renewable feedstock preferably includes waste and residue materials originating from animal fat/oil, plant fat/oil or fish fat/oil. These may comprise sludge palm oil, such as palm effluent sludge (PES) or palm oil mill effluent (POME), used cooking oil (UCO), acid oils (ASK), brown grease (BG), sludge palm oil, spent bleaching earth oil (SBEO), technical corn oil (TCO) or lignocellulosic based oils, municipal solid waste-based oils or algae-based oils. Most preferably, the feeds include UCO, sludge palm oil, TCO and algae-based oils.

### Pre-Treatment

Typically, the waste and residue materials contain a wide variety of heteroatomic compounds, which often are more difficult to remove by conventional feedstock pre-treatments typically used for pre-treatment of matrices comprising triacylglycerols. The waste and residue materials may comprise accumulated alkali and earth alkaline metals, such as sodium, potassium, calcium, magnesium; other metals such as iron or copper; nitrogen containing compounds, such as amines and amides; phosphorus containing compounds, such as phospholipids; silicon containing compounds, such as siloxanes and polydimethylsiloxanes (PDMS); halides, sulphur containing compounds, etc. depending on the type of residue/waste. These materials are typically harmful for the catalyst used in hydrotreatment and isomerization and need to be decreased or removed before entering the feedstock onto the catalysts.

Depending on the level of pre-treatment, fats, oils, and greases may contain high amounts of impurity materials e.g., about 1-1000 w-ppm (ppm by weight) phosphorus; and about 1-500 w-ppm total metals, mainly sodium, potassium, magnesium, calcium, iron, and copper. Nor is it uncommon that animal fat can contain e.g., 1000 w-ppm or even higher nitrogen measured as elemental nitrogen.

The feedstock of the present method needs to be suitable for hydrodeoxygenation. Typically, the feedstock entering into a hydrodeoxygenation reactor or a catalyst bed thereof should not include more than 10 w-ppm, preferably not more than 5 w-ppm, more preferably not more than 1 w-ppm alkali metal and alkaline earth metal impurities, calculated as elemental alkaline and alkaline earth metals; not more than 10 w-ppm, preferably not more than 5 w-ppm, more preferably not more than 1 w-ppm other metals, calculated as elemental metals; not more than 1000 w-ppm, preferably not more than 500 w-ppm, more preferably not more than 150 w-ppm, most preferably not more than 50 w-ppm, such as not more than 5 w-ppm, such as not more than 1 w-ppm nitrogen containing impurities, calculated as elemental nitrogen; not more than 30 w-ppm, preferably not more than 15 w-ppm, more preferably not more than 5 w-ppm, such as not more than 1 w-ppm phosphorus containing impurities, calculated as elemental phosphorus; not more than 5 w-ppm, preferably not more than 1 w-ppm silicon containing impurities, calculated as elemental silicon; optionally not more than 100 w-ppm, preferably not more than 50 w-ppm, most preferably not more than 30 w-ppm, such as not more than 10 w-ppm, such as not more than 5 w-ppm sulphur containing impurities, calculated as elemental sulphur, and optionally not more than 20 w-ppm, preferably not more than 10 w-ppm, more preferably not more than 5 w-ppm chlorine containing impurities, calculated as elemental chlorine. Depending on the efficiency of the hydrotreating catalyst bed system and the hydrotreatment reactor unit configuration even a high amount of nitrogen impurities in the feed may be tolerated, and the effluent from the HDO may contain suitably low amount of nitrogen impurities to enable subjecting it to subsequent catalytic processes.

There are several known methods to remove or decrease the amount of harmful materials, and varying purification or pre-treatment methods are commonly applied. Exemplary pre-treatment methods suitable for the present disclosure comprise treating with mineral acids, degumming, treating with hydrogen, heat treating, deodorizing, washing with water, treating with base, demetallation, distillation, removal of solids, bleaching, and any combinations thereof.

Contaminating metals may be removed from the feedstock e.g., by treatment with mineral acids. Phosphorus which mostly occurs in the form of phosphates may be removed by degumming. Triglycerides can also be pre-hydrogenated (pre-treated with hydrogen). Besides reducing the amount of oxygen containing compounds (HDO), unsaturation, sulphur, and nitrogen content (HDS, HDN) are reduced. Solid feedstocks such as fats, in turn should be liquified e.g., by heating prior to subjecting to hydrodeoxygenation. Pre-treatment of solid feedstocks may further include one or more of: grinding, agitating, filtering, and sonicating. The feedstock may further be bleached and/or deodorized.

The pre-treatment can be selected from heat treatment optionally followed by evaporation of volatiles; heat treatment with adsorbent (HTA), optionally followed by flash evaporation; degumming; bleaching. According to one embodiment the pre-treatment includes any one of, any combination of, or all of a degumming step, a chemical treating step, a water-wash step, a demetallation step, a bleaching step, a full (or partial) hydrogenation step, an acid gas removal step, and/or a water removal step. The pre-treatment also typically comprises a step of removing impurities from the feedstock, including any suitable removal of solids from a liquid, including filtration, centrifugation, and sedimentation; and removing volatiles from liquid, e.g., by evaporation. In the pre-treatment the feedstock comprising organic material of biological origin, as previously defined, is purified and a purified feedstock is obtained.

In one embodiment the pre-treatment is selected from heat treatment optionally followed by evaporation of volatiles, whereby the feedstock is heated at a temperature of from 80° C. to 325° C., preferably 180° C. to 300° C., more preferably 200° C. to 280° C., in a residence time from 1 to 300 min. The heat treatment can be followed by an evaporation step, where especially silicon and phosphorus containing compounds are removed. An example of heat treatment of a feedstock comprising organic material can be found in WO 2020/016405. Heat treatment can also be followed by filtration as an addition or an alternative to evaporation. When the feedstock comprises brown grease or acidulated soap stock the pre-treatment comprises typically heat treatment with or without a filter-aid (adsorbent) followed by filtration and possible bleaching.

In one embodiment the pre-treatment is selected from heat treatment with adsorbent (HTA) optionally followed by flash evaporation. HTA as pre-treatment is especially suitable when the feedstock comprises CTO and/or TOP, but HTA is also suitable for other feedstocks. Heat treatment with adsorbent (HTA) can be performed in a temperature from 180° C. to 325° C., preferably from 200° C. to 300° C., more preferably from 240° C. to 280° C., optionally in the presence of an acid. The adsorbent can be selected from alumina silicate, silica gel and mixtures thereof and is typically added in an amount of 0.1 wt-% to 10 wt-%, such as 0.5 wt-%. An example of HTA can be found in WO 2020/016410.

In one embodiment the pre-treatment is selected from bleaching. Bleaching can be conducted by acid addition in an amount of from 500 to 5000 ppm based on feed. The bleaching treatment can be performed in a temperature from 60° C. to 90° C. and including a drying step in 110° C. to 130° C. The bleaching is finished by a filtration step to remove formed solids and possible filter aids. In one example bleaching includes the following sequence
(1) acid addition 1000-4000 ppm citric acid (50 wt-% water) 85° C., 10 min;
(2) adsorbent/filter aid addition 0.1-1 wt-%, 85° C., 800 mbar, 20 min;
(3) drying 120° C., 80 mbar, 25 min
(4) filtering 120° C., 2.5 bar.

Both heat treatment (HT) and heat treatment with adsorbent (HTA) can be performed under pressure, the pressure can be 500 to 5000 kPa. Also, water can be added before or during HT and HTA to a level of up to 5 wt-%, such as 1 wt-%-3 wt-%. The evaporation e.g., flashing can be performed after HT or HTA or any other pre-treatment stage and can be performed at about 160° C., such as from 150° C. to 225° C., in a pressure of 10 to 100 mbar.

In one embodiment the pre-treatment comprises heat treatment (HT) and bleaching.

In one embodiment the pre-treatment comprises heat treatment (HT) with alkali addition and bleaching.

In one embodiment the pre-treatment comprises heat treatment with adsorption (HTA) followed by flash (removal of light components comprising Si components etc. by evaporation) and bleaching.

In addition, the pre-treatment may or may not include additional steps such as removal of solids (using technologies such as centrifugation or filtration) before and/or after HT or HTA, water washing, degumming, hydrolysis, distillation, strong acid treatment, 2nd bleaching or any combination of the mentioned methods.

Feedstock suitably purified by pre-treatment prolongs the catalyst life cycle in hydrodeoxygenation and subsequent reactions like isomerization or cracking.

### Hydrodeoxygenation (HDO)

As defined herein deoxygenation is a method for the removal of covalently bound oxygen from organic molecules. Hydrodeoxygenation refers herein to removal of oxygen as H₂O, CO₂ and/or CO from the oxygen containing hydrocarbons by hydrodeoxygenation, decarboxylation and/or decarbonylation. Whereas during catalytic cracking, there will be acid catalysed breaking down of C—C bonds of hydrocarbons or breaking down long chained hydrocarbons to form shorter hydrocarbon chains or branching or cyclisation without the need for presence of molecular hydrogen, merely under the influence of a suitable catalyst.

As defined herein hydrogenation is a method for saturation of carbon-carbon double bonds by means of molecular hydrogen under the influence of a catalyst.

The hydrotreatment comprising deoxygenation and isomerisation reactions may be conducted in a single reactor conducting hydrodeoxygenation and isomerisation reactions in same or subsequent catalyst beds, in multiple catalyst bed systems, or in separate reactors. Preferably, the deoxygenation and isomerisation reactions of the hydrotreatment are conducted in separate deoxygenation and isomerisation steps in subsequent catalyst beds in a same reactor or in separate reactors.

According to the present method the pre-treated feedstock is subjected to hydrodeoxygenation. The hydrodeoxygenation of renewable oxygen containing hydrocarbons is performed at reaction conditions comprising one or more of
a. a temperature in the range from 250° C. to 400° C., preferably from 260° C. to 380° C., more preferably from 280° C. to 360° C., such as from 300° C. to 330° C.,
b. a pressure in the range from 10 bar to 200 bar, preferably from 20 bar to 100 bar, more preferably from 20 bar to 80 bar,
c. a weight hourly space velocity (WHSV) in the range from 0.25 h⁻¹ to 3.0 h⁻¹, preferably from 0.7 h⁻¹ to 3.0 h⁻¹, more preferably from 1.0 h⁻¹ to 2.5 h⁻¹, most preferably from 1.0 h⁻¹ to 2.0 h⁻¹, depending on the hydrogen consumption,
d. a H₂ flow in the range from 350 to 1500 N-L H₂/L feed, more preferably from 350 to 1100 N-L H₂/L feed, most preferably from 350 to 1000 N-L H₂/L feed, wherein N-L H₂/L means normal litres of hydrogen per litre of the feed into the HDO reactor, and
e. a hydrodeoxygenation catalyst selected from Pd, Pt, Ni, Co, Mo, Ru, Rh, W, or any combination of these on a support, preferably Ni, Co, Mo, and W, on a support.

According to one embodiment the hydrodeoxygenation catalyst is selected from a group consisting of CoMo, NiMo, NiW, and CoNiMo on a support, wherein the support is preferably alumina and/or silica.

According to a particular embodiment the hydrodeoxygenation reaction conditions comprise temperature in the range from 250° C. to 400° C., pressure in the range from 20 to 80 bar, a WHSV in the range from 0.5 h⁻¹ to 3 h⁻¹, and H₂ flow of 350-1500 N-L H₂/L feed, and a hydrodeoxygenation catalyst.

In one embodiment, the hydrodeoxygenation of renewable oxygen containing hydrocarbons is most preferably carried out in the presence of sulphided NiMo or sulphided CoMo catalysts on a support in the presence of hydrogen gas. Using a sulphided catalyst, the sulphided state of the catalyst may be maintained during the HDO step by an addition of sulphur in the gas phase or by using a feedstock having sulphur containing mineral oil blended with the renewable oxygen containing hydrocarbons. Sulphur may be deliberately added to the feedstock being subjected to hydrodeoxygenation, for example, within a range from 50 w-ppm (ppm by weight) to 20 000 w-ppm, preferably within a range from 100 w-ppm to 1000 w-ppm, when using hydrodeoxygenation catalysts requiring a sulphided form for operation.

Effective conditions for hydrodeoxygenation may reduce the oxygen content of the HDO effluent to less than 1 wt-%, such as less than 0.5 wt-% or less than 0.2 wt-%.

### Purification of the Hydrodeoxygenated Stream

The effluent of the hydrodeoxygenation, i.e. the hydrodeoxygenated stream, may be purified before hydroisomerization. Typically, the purification includes subjecting the effluent to a gas-liquid separation, i.e. removing gases such as carbon monoxide, carbon dioxide, water, possible hydrogen disulphide and ammonia, and low boiling hydrocarbons, such as C1-C4 compounds, from the liquid hydrocarbon stream. In the gas-liquid separation the hydrotreated effluent is separated into a gaseous stream and into a hydrotreated liquid stream, which separation may be a stripping step or be followed by a stripping step, where the hydrotreated liquid stream may be stripped with a stripping gas, such as hydrogen. Alternatively, the gas-liquid separation may take place even before the exit from the hydrodeoxygenation step, such as at the bottom part of the hydrodeoxygenation reactor complemented by condensation. The liquid-gas separation may be carried out at a high temperature and/or high-pressure separation step, for example, at a temperature between 300° C. and 330° C. and pressure between 40 bar and 50 bar.

The advantage of the gas-liquid separation is that it avoids carrying over detrimental impurities present to the sensitive isomerization catalyst.

In one embodiment, the purification may further include separating of high and low boiling hydrocarbons, such as removing C17 and higher hydrocarbons from the effluent stream e.g. by distillation. An advantage of removal of higher hydrocarbons is that cracking of the formed paraffins, such as n-paraffins, during the hydroisomerization step is not required.

The hydrodeoxygenated liquid stream directed to hydroisomerization comprises preferably at least 92 wt-%, more preferably at least 95 wt-%, most preferably at least 99 wt-%, such as 99.5 wt-%, paraffins of the total weight of the hydrocarbons, and may still include some oxygen impurities.

In one embodiment, the obtained hydrodeoxygenated stream directed to hydroisomerization is mainly in a liquid form.

The amount of n-paraffins is high, preferably more than 85 wt-%, more preferably more than 90 wt-%, e.g. such as 95 wt-%, especially when using NiMo/Al₂O₃ as the hydrodeoxygenation catalyst.

It is generally known that alkane and paraffin are synonyms and can be used interchangeably. Isoparaffins (i-paraffins) are branched, open chain paraffins, and normal paraffins (n-paraffins) are unbranched linear paraffins. In the context of this disclosure, the term “paraffin” refers to n-paraffins and/or isoparaffins. Similarly, the term “paraffinic” refers herein to compositions comprising n-paraffins and/or isoparaffins.

### Hydroisomerization

The hydroisomerization reaction of the method of the present invention is performed in the presence of a metal-impregnated hierarchical ZSM-23 catalyst.

By hierarchical ZSM-23 is meant a ZSM-23 based zeolite catalyst wherein additional mesoporosity, or even macroporosity, may be introduced into the microporous parent zeolite thus modifying the properties of the catalyst. The secondary porosity facilitates diffusion of reactants and products into and out of the zeolite structure, such as longer chain hydrocarbon molecules, while the intrinsic microporosity maintains the size, shape, and transition state selectivity of the zeolite. A ZSM-23 zeolite used as the parent is a one-dimensional oval shaped 0.45×0.52 nm (non-circular) 10-ring pore system.

The hierarchical hydroisomerization catalyst used in the present method may be prepared from a parent ZSM-23 using a top-down approach disclosed e.g. by Jia et al. Advanced Powder Technology 30 (2019) 467-484, followed by metal impregnation and calcination as disclosed e.g. by Gao et al, Petroleum Science, 2020 (doi: 10.1007/s12182-020-00500-7).

In the present disclosure the parent ZSM-23 zeolite has the following properties: Si amount is about 41 wt-%; Al amount is such as 1.9 wt-%; SiO₂/Al₂O₃ molar ratio is about 42; the crystallinity is about 60%, measured by X-ray diffraction (XRD) according to ASTM D5758-01 (2021); and the BET surface area is about 214 m²/g, measured by N₂ physisorption; and the ratio of Brønsted to Lewis acid sites is about 15, measured by the pyridine FT-IR. The parent ZSM-23 zeolite further comprises needle-like particles of a size below 2 μm.

In the hierarchical ZSM-23 the volume of the mesopores and micropores and their ratio varies, especially compared to the parent ZSM-23. Equally, the acidity and the SiO₂/Al₂O₃ ratio may vary. Preferably, in the hierarchical ZSM-23 of the present disclosure the volume of the micropores is more than 0.03 mL/g, preferably more than 0.06 mL/g, the volume of the mesopores is more than 0.25 mL/g, preferably more than 0.60 mL/g, the pore volume is from 0.6 to 0.8 mL/g. The BET surface area of the hierarchical ZSM-23 may be more than 250 m²/g. The pore volumes and surface areas of the zeolites are measured with the commonly used nitrogen physisorption method described in ASTM D3663 M for BET surface area and ASTM D4641-M for pore size/volume. Before the measurement the samples are treated by VacPrep™ and Smart VacPrep system stepwise at 90° C. and 300° C. Tristar II (3020) system was further used for the measurement of the pore volume and surface area.

The hierarchical ZSM-23 of the present disclosure may have a ratio of the Brønsted acid sites to the Lewis acid sites more than 15, such as more than 20, measured by pyridine FT-IR. For this measurement a self-supported wafer is made out of a 100 mg sample. The sample is activated in the FT-IR cell at 450° C. for one hour and then cooled to 170° C. At this temperature pyridine is desorbed. The band around 1450 cm-1 is used to calculate the Lewis-acid sites while the band of pyrH⁺ on Brønsted sites is around 1540 cm-1. The dimensions of the wafer and the extinction factors of 1.42 and 1.88 are used for determination of the concentration of Lewis and Brønsted acid sites, respectively.

Moreover, the crystallinity of the hierarchical ZSM-23 is clearly lower than the crystallinity of the parent ZSM-23. It may be less than 60%, or even less than 50%, such as from 30 to 50%, such as about 46%, whereas the parent ZSM-23 typically has a crystallinity of at least 60% or more, such as up to 70%. The decrease in crystallinity is confirmed by TEM (transmission electron microscope) images. The crystal size itself is not markedly affected, showing a less than 5% decrease compared to the parent, such as about 16 nm. The crystallinity and crystal sizes of zeolites may be measured with X-ray diffractogram (e.g. PANalytical Empyrean 3). The crystals of parent ZSM-23 are needle-like. This is predominantly the case in the hierarchical ZSM-23, as well, however, to a lesser extent as its structure is more amorphous.

The hierarchical ZSM-23 may be impregnated with catalytically active metals selected from platinum, palladium, nickel, and iridium and any combinations thereof, such as Pt, Pd, Pt—Pd and Ni. The metal content may be from 0.1 wt-% to 5.0 wt-%. The impregnation may be achieved by known dry or wet methods. According to an exemplary embodiment Pt is impregnated using an aqueous Pt(NH₃)₄Cl₂ or Pt(NH₃)₄(NO₃)₂ solution. The metal, in particular platinum, may be added to the zeolite alone or to the zeolite with a binder such as alumina or silica or alumina-silica.

According to a preferable embodiment the metal is platinum. The Pt content may be from 0.3 wt-% to 1.0 wt-%, preferably from 0.4 wt-% to 0.6 wt-%, such as about 0.5 wt-%. The metal loading and dispersion are important factors in order to have a proper balance between the metal and the acid functions in the catalyst. A loading around 0.5-1.0 wt-% creates a good balance between metallic and acid sites. The amount of platinum neither affects the surface area nor acidity of the final catalyst.

In these experiments, the size of platinum particles is increased, and the dispersion hereof is decreased in the Pt impregnated hierarchical ZSM-23 compared to those of the parent ZSM-23. The platinum particle size is increased by about 5%, or 15% at the most, based on its average size in nanometers. The dispersion of platinum is decreased by about 10%, or 15% at the most, compared to the Pt dispersion in the parent ZSM-23, based on the percentage of hydrogen chemisorption. The increased Pt particle size and in turn lower dispersion would imply a worse catalytic efficiency if the assessment would be merely based on the Pt quality.

According to one embodiment the hierarchical ZSM-23 of the catalyst has one or more of the following features:
i. volume of micropores more than 0.03 mL/g, preferably more than 0.06 mL/g,
ii. volume of mesopores more than 0.25 mL/g, preferably more than 0.60 mL/g,
iii. ratio of Brønsted acid sites to the Lewis acid sites of more than 15, preferably more than 20, as determined by pyridine FT-IR,
iv. SiO₂/Al₂O₃ molar ratio from 45 to 90, preferably from 55 to 80, more preferably from 60 to 70, and
v. crystallinity less than 60%, preferably less than 50% as measured by XRD according to ASTM D5758-01 (2021).

The Pt impregnated hierarchical ZSM-23 catalyst may further comprise a support material, such as alumina, silica, or alumina-silica.

In one embodiment, the Pt impregnated hierarchical ZSM-23 catalyst is used. The hierarchical ZSM-23 present in the catalyst has one or more of the following features: A volume of micropores more than 0.03 mL/g, preferably 0.06 mL/g; A volume of mesopores more than 0.25 mL/g, preferably 0.60 mL/g; A ratio of the Brønsted acid sites to the Lewis acid sites of more than 15, preferably more than 20 (determined by pyridine FT-IR); SiO₂/Al₂O₃ molar ratio from 45 to 90, preferably from 55 to 80, more preferably from 60 to 70; Crystallinity less than 60%, preferably less than 50%. The catalyst further comprises a support, wherein the support may comprise alumina and/or silica and is preferably alumina.

In a preferred embodiment the Pt impregnated hierarchical ZSM-23 catalyst has a volume of micropores more than 0.06 mL/g, a volume of mesopores more than 0.6 mL/g, Brønsted acid sites to the Lewis acid sites of more than 15, preferably more than 20 (determined by pyridine FT-IR), SiO₂/Al₂O₃ molar ratio from 60 to 70, and crystallinity less than 50%. The catalyst further comprises a support, wherein the support is alumina.

The hydroisomerisation is performed at a temperature from 250° C. to 340° C., preferably from 270° C. to 310° C., more preferably from 270° C. to 290° C. The temperature may be dependent on the metal and the loading thereof in the catalyst. As noble metals are known to be more active compared e.g. to Ni, Ni may require higher temperatures. The influence of increasing temperature may be compensated by the amount of metal loading.

In one embodiment the isomerisation temperature for the catalyst comprising a noble metal from 0.1 to 1.0 wt-% is from 250° C. to 320° C.

In one embodiment the isomerisation temperature for the catalyst comprising Ni from 1.0 to 5.0 wt-% is from 300° C. to 340° C.

An exemplary temperature is about 280° C. The processing temperature refers to the temperature at the process inlet. Pressure is typically from 10 bar to 150 bar, preferably from 10 bar to 50 bar, more preferably from 30 bar to 50 bar. An exemplary preferable pressure is about 40 bar. The WHSV is preferably from 1 h⁻¹ to 10 h⁻¹, and H₂ flow is typically from 100 to 900 N-L H₂/L feed, preferably from 200 to 650 N-L H₂/L feed, more preferably from 200 to 400 N-L H₂/L feed.

The use of a metal impregnated hierarchical ZSM-23 catalyst is observed to clearly increase the accessibility of the acid sites of the material for larger molecules thus rendering diffusion limitations moot and enabling and enhancing multi branching of the molecules.

The degree of branching in terms of di-, tri- and tetramethyl branches were increased in the isomerised product compared to using a non-hierarchical zeolite, anticipating superior cold flow properties for the obtained products or product components. The current results further imply that it may be possible to produce renewable aviation fuel or components thereto at a lower temperature i.e. below 300° C., and with an increased quality due to multi branching compared to typically used isomerisation catalysts.

It was found particularly advantageous to use separate steps or reactors for the hydrodeoxygenation and for the isomerisation to be able to freely select the most optimal reaction conditions, such as temperatures and pressures, independently for both steps. Moreover, any interference due to catalysts or reaction phase products could be eliminated, thus ensuring optimal infeed onto the catalysts. For example, 5 removal of possibly formed hydrogen disulphide from the hydrodeoxygenation effluent before contacting it with the isomerisation catalyst, such as Pt, is preferred.

Use of the low temperature isomerisation catalyst of the present disclosure further enables performing the whole processing at a lower temperature than typically used. The increased mesoporosity of the hierarchical catalyst changes the transition states of the adsorbed species, thus enabling and aiding in the formation of the multibraching, even at lower temperatures. This type of structure further mitigates the transport limitations resulting in an increased selectivity towards multibranched components. Multi branching is likely to be affected by the acid strength, as well.

In one embodiment the catalyst of the present disclosure may be pre-treated by at least one or several of the following steps: Drying, preferably at a temperature of about 125° C. for 8 h under N₂ or H₂ flow; Reducing, preferably at a temperature of about 350° C. for 2 h at a pressure of about 40 bar under H₂ flow; Wetting, preferably at a temperature of about 200° C. for 2 h at a pressure of about 40 bar under H₂ flow; Stabilising, preferably at a temperature of about 200° C. for 2 h at a pressure of about 40 bar under H₂ flow.

In one embodiment, the Pt impregnated hierarchical ZSM-23 catalyst is reduced. The reduction may take place at a temperature from 330° C. to 370° C., preferably about 350° C., the reduction time may be from 1.5 to 2.5 h, preferably about 2 h, the pressure is from 35 bar to 45 bar, preferably about 40 bar, and under H₂ gas flow.

Optionally, after reduction of the catalyst, passivation of the most active and/or acidic sites can be performed, for instance by adding tributylamine (0.2 wt-%) at 150° C. and 40 bar and in the presence of hydrogen (300 N-L H₂/L liquid feed) until 15 g of tributylamine per gram of catalyst have been fed. In this way the initially high cracking selectivity can be diminished and the selectivity towards multibranched C8-C16 can be increased. Selection of temperature, time and the passivating molecule impacts the selectivity of the different fractions, as well as the reaction conditions of the actual process.

### Stabilisation

There may be further steps included either combined with the hydroisomerization step or thereafter, as separate process steps. These may comprise further stabilization by e.g. purification or fractionation. Typically, such additional process steps allow better control of desired properties of the effluent.

The isomerization step may comprise an optional stripping step, or there may be a separate optional stripping step after the isomerisation step, such as an additional stripping, in a stabilization column. In the stripping the reaction product or effluent from the hydrotreatment step may be purified by stripping with water vapour or a suitable gas such as light hydrocarbon, nitrogen, or hydrogen.

### Separation of the Products

The hydroisomerized stream, optionally the stabilised hydroisomerized effluent from the hydroisomerization, is subjected to separation using conventional separation processes, such as fractionation through distillation at atmospheric pressure and/or at reduced pressure. The fractionation is used to separate the hydroisomerized stream at least into a fraction suitable for use as renewable aviation fuel, or components thereto. In the present disclosure aviation fuel comprises the “jet fuel range” hydrocarbons, referring to blends or components thereto fulfilling the ASTM D7566 requirements, as well as the “naphtha range” hydrocarbons suitable for use as avgas i.e. aviation gasoline, referring to blends or components thereto fulfilling the properties required by the Defence Standard 91-090.

In the present disclosure at least the renewable aviation fuel or components thereto is separated from the hydroisomerized stream, or the stabilized hydroisomerized stream.

According to one embodiment the separation is used to separate the hydroisomerized stream, or the stabilized hydroisomerized stream, into
(i) A fraction comprising renewable C10-C18 hydrocarbons, preferably C10-C16 hydrocarbons, such as branched C16-C18 hydrocarbons or branched C10-C16 hydrocarbons which are suitable for use in aviation fuel applications, such as jet fuel or components thereto. The separated hydrocarbon fraction has preferably an initial boiling point at atmospheric pressure of at least 150° C. and a final boiling point of up to 290° C.
(ii) A fraction comprising renewable C5-C9 hydrocarbons, such as branched C5-C9 hydrocarbon which are naphtha range hydrocarbons, suitable for use in selected aviation fuel applications, such as avgas or components thereto or as renewable naphtha or components thereto. The separated hydrocarbon fraction has preferably an initial boiling point at atmospheric pressure of at least 60° C. and a final boiling point of up to 150° C.

In one embodiment, the hydroisomerized stream, or the stabilized hydroisomerized stream, is further separated into a further fraction (iii) comprising renewable C1-C4 hydrocarbons, which are the gas range hydrocarbons, preferably wherefrom C3-C4s are separated, and where from e.g. C3 hydrocarbons like propane may be recovered.

In one embodiment, the separation is made to
A fraction rich in renewable C1-C2 hydrocarbons.
A fraction rich in renewable C3-C4 hydrocarbons.
A fraction rich in renewable C5-C9 hydrocarbons a.k.a. fraction suitable for use as aviation gasoline (avgas) fuel or components thereto.
A fraction rich in renewable C10-C18 hydrocarbons, preferably C10-C16 hydrocarbons a.k.a. fraction suitable for use as sustainable aviation fuel or components thereto, namely jet fuel or components thereto.

As defined herein, a fraction “rich in” means in the context of the present disclosure that the wt-% amount of the hydrocarbons in the fraction, based on the total weight of the fraction, is higher than the wt-% amount of the hydrocarbons in the hydroisomerized stream, or optionally in the stabilized hydroisomerized stream, based on the total weight of the hydroisomerized stream, or the optionally stabilized hydroisomerized stream.

The possible remainder of hydrocarbons higher than C18, preferably higher than C16 may be recovered and used for e.g. diesel fuel production

A process for preparing renewable hydrocarbons suitable for use as aviation fuel, such as renewable aviation fuel or sustainable aviation fuel, from an oxygenated i.e. oxygen containing renewable feedstock is disclosed.

By aviation fuel suitable for conventional jet turbine engines is meant a hydrocarbon blend or a component thereto suitable for use as aviation fuel fulfilling the requirements of ASTM D7566-22. For the determination of distillation characteristics and boiling ranges, reference is made to EN ISO 3405:2019. For boiling point distribution, reference may also be made to gas chromatography-based methods like ASTM D2887-19e1. Typically, C18 paraffins boil at 317° C. and should not be used as an aviation fuel component. However, even if C18 hydrocarbons do not really fit within the required boiling range which is set for the aviation fuel according to ASTM D7566-22 a very limited amount of C18 hydrocarbons, specifically multibranched C18 hydrocarbons, may be comprised in the aviation fuel component, depending on its desired properties.

By renewable aviation fuel suitable for use in conventional jet turbine engines is meant aviation fuel or components thereto which have been manufactured from renewable feedstock. By sustainable aviation fuel (SAF) is herein meant renewable aviation fuel which is produced sustainably and is able to reduce GHG emissions, preferably at least 70%, such as about 80%, compared to fossil jet fuel baseline, and helps the aviation industry to meet the ambitious CO₂ reduction targets for the future.

In the present disclosure sustainable aviation fuel comprises, in addition to SAF suitable for jet fuel, also SAF suitable for use as aviation gasoline (the same as avgas) that is used in different types of engines, namely, in aircraft spark ignition reciprocating engines. Avgas is gasoline type aviation fuel fulfilling the requirements of Defence Standard 91-090 (2019).

According to one embodiment, the obtained renewable aviation fuel comprises at least 40 wt-%, preferably at least 60 wt-%, more preferably at least 70 wt-%, by weight paraffins comprising at least two branched methyl groups.

In one embodiment the obtained branched hydrocarbons, in the renewable aviation fuel component range, comprised paraffins with branched dimethyl groups, branched trimethyl groups and branched tetramethyl groups. Preferably, the amount of branched dimethyl groups in the branched hydrocarbons is at least 2 times the amount of the branched trimethyl or higher branched methyl groups in the branched hydrocarbons. Branched dimethyl groups in the branched hydrocarbon provide better cold properties compared to branched monomethyl groups, and they have a minor tendency to crack into lighter products compared to branched trimethyl or higher branched methyl groups.

According to a particular embodiment the renewable aviation fuel comprises at least 95 wt-%, preferably at least 97 wt-%, i-paraffins.

According to another particular embodiment the C16-C18 hydrocarbons of the renewable aviation fuel comprise at least 70 wt-% multibranched C16-C18 hydrocarbons, i.e. C16-C18 hydrocarbons having more than one i-alkyl group, such as dimethyl, trimethyl, tetramethyl, or corresponding ethyl groups.

According to another particular embodiment the C16 hydrocarbons of the renewable aviation fuel comprise at least 70 wt-% multibranched C16 hydrocarbons, i.e. C16 hydrocarbons having more than one i-alkyl group, such as dimethyl, trimethyl, tetramethyl, or corresponding ethyl groups.

The present disclosure provides also new use of a metal impregnated hierarchical ZSM-23 catalyst, wherein the metal is selected from platinum, palladium, nickel and iridium, and any combinations thereof, such as Pt, Pd, Pt—Pd, and Ni, for producing renewable aviation fuel or components thereto from a renewable paraffinic feed by hydroisomerization at a temperature from 250° C. to 340° C., and in the presence of hydrogen flow. The metal is preferably Pt. The hierarchical ZSM-23 of the Pt impregnated catalyst has one or more of the following features:
i. volume of micropores more than 0.03 mL/g, preferably more than 0.06 mL/g,
ii. volume of mesopores more than 0.25 mL/g, preferably more than 0.60 mL/g,
iii. Brønsted acid sites to the Lewis acid sites of more than 15, preferably more than 20, determined by pyridine FT-IR,
iv. SiO₂/Al₂O₃ molar ratio from 45 to 90, preferably from 55 to 80, more preferably from 60 to 70, and
v. crystallinity less than 60%, preferably less than 50%, as measured by XRD according to ASTM D5758-01 (2021).

The metal impregnated hierarchical ZSM-23 catalyst further comprises a support, wherein the support is preferably alumina and/or silica.

### EXPERIMENTAL

A fresh Pt impregnated hierarchical ZSM-23 catalyst material according to the preferred embodiment of this disclosure, and its parent Pt-impregnated ZSM-23 material, were tested in a test reactor system comprising 16 individual fixed-bed reactors, which could be run in parallel. The Pt loading of both catalysts was comparable, and the catalysts were not passivated. The first reaction temperature was 280° C., after which the temperature was increased to 310° C. in all the reactors. As HDO effluent feed, n-hexadecane was used. After that, the temperature was decreased to 295° C. The used process parameters are summarized below:
Drying: 125° C., 8 h, N₂ flow
Reduction: 350° C., 2 h, 40 bar, H₂ flow
Wetting: 200° C., 2 h, 40 bar, H₂ flow
Stabilization: 200° C., 2 h, 40 bar, H₂ flow.
Reaction: 280-340° C., 40 bar, WHSV 1.3 h⁻¹, H₂/oil ratio 300 N-L/L feed, 40 mg catalyst (50-100 μm)

The analysis of the gaseous products was made with an online GC (Agilent 7890). The analysis of the liquid products was made with an offline GC (QP2010 Ultra El, Shimadzu) having an FID detector and a mass spectrometer. The quality of the obtained liquid products were assessed with GC*GC analysis.

The GC*GC analysis results (Table 1) confirmed that the degree of branching can be significantly increased by using the hierarchical Pt/ZSM-23 based catalyst compared to the parent Pt/ZSM-23 catalyst. The used hierarchical Pt/ZSM-23 catalyst produced less methyl-branched C16 and more dimethyl-branched C16 compared to the parent Pt/ZSM-23 catalyst. The hierarchical Pt/ZSM-23 catalyst produced 47% dimethyl-branched C16 compared to the parent Pt/ZSM-23 catalyst (25%). Moreover, even tri- and tetramethyl-branched C16s were observed in a significant amount with the hierarchical Pt/ZSM-23 but these multi branched isomers were hardly present with the parent Pt/ZSM-23 catalyst. Furthermore, the highest total amount of i-paraffins throughout the carbon number distribution from C5 to C30 was found to be higher with the hierarchical Pt/ZSM-23.

TABLE 1
Isomerization degree of C16 hydrocarbons (wt. % in liquid
product) at 280° C. with the Pt/ZSM-23-based catalysts.

| | | | | t ri- | | total i- | |
|---|---|---|---|---|---|---|---|
| | | | di-me- | me | tetra- | paraffins | C4+ yield/ |
| Catalyst | n-C16 | me-C16 | C16 | C16 | me- C16 | in liquid | mol. %* |
| Pt/ZSM-23 | 3.9 | 64.3 | 25.3 | 2.2 | 0.1 | 94.1 | 91.4 |
| parent | | | | | | | |
| Pt/ZSM-23 | 1.2 | 19.9 | 47.1 | 24.0 | 2.0 | 97.3 | 87.9 |
| hierarchical | | | | | | | |

*From liquid and gas phase GC analysis.

The conversion of the feed using the Pt/ZSM-23 catalysts at different temperatures is presented in Table 2. Pt/ZSM-23 parent was loaded to two reactors (different batches of the prepared Pt catalysts) to estimate the repeatability of the catalyst preparation (Pt impregnation) and the test run itself. The Pt/ZSM-23-based catalysts were very active already at 280° C. with conversions close to 100 wt %. The hierarchical Pt/ZSM-23 was more active at 280° C. than the parent catalyst. Further increasing the temperature to 295° C. and 310° C. increased the conversions to 100 wt-% for all the materials.

TABLE 2
Feed conversion (wt-%) at different reaction temperatures using the
Pt/ZSM-23-based catalysts.

| Catalyst | t = 280° C. | t = 295° C. | t = 310° C. |
|---|---|---|---|
| Pt/ZSM-23 parent | 97.5 | 99.9 | 100 |
| Pt/ZSM-23 parent | 97.0 | 99.8 | 100 |
| Pt/ZSM-23 | 99.5 | 100 | 100 |
| hierarchical | | | |

Table 3 shows the product yields at 280° C. The highest C10-C16 yield i.e. the jet fuel range yield of 70 wt-% was obtained with the parent Pt/ZSM-23 already at 280° C. The hierarchical catalyst, produced somewhat less C10-C16 hydrocarbons but more C5-C9 hydrocarbons i.e. the naphtha range components at 280° C. However, the hierarchical Pt/ZSM-23 is considered to be a potential catalyst for aviation fuel range hydrocarbon production when considering activity, selectivity, and branching, and especially in view of the possibility to fine tune the catalyst by e.g. passivation.

TABLE 3
Product selectivities of feed conversion (wt %) at 280° C. using
the ZSM-23-based catalysts.

| Catalyst | C1-C4 | C5-C9 | C10-C16ª |
|---|---|---|---|
| Pt/ZSM-23 parent | 6.0 | 22.3 | 71.7 |
| Pt/ZSM-23 parent | 4.6 | 17.7 | 77.8 |
| Pt/ZSM-23 hierarchical | 11.3 | 37.3 | 51.4 |

^{a}n-C16 was not detected

The product yields and product selectivities for the conversion of the feed using the hierarchical Pt/ZSM-23 at different temperatures are presented in tables 4 and 5, respectively.

TABLE 4
Product selectivities of feed conversion (wt %) using the hierarchical
ZSM-23 catalyst.

| Temperature/° C. | C1-C4 | C5-C9 | C10-C16ª |
|---|---|---|---|
| 280 | 11.3 | 37.3 | 51.4 |
| 295 | 19.4 | 63.4 | 17.2 |
| 310 | 28.2 | 66.2 | 5.6 |

^{a}n-C16 was not detected

TABLE 5
Product yields of feed conversion (wt %) using the hierarchical
ZSM-23 catalyst.

| Temperature/° C. | C1-C4 | C5-C9 | C10-C16ª |
|---|---|---|---|
| 280 | 10.8 | 34.4 | 47.1 |
| 295 | 19.5 | 60.8 | 16.5 |
| 310 | 29.9 | 67.5 | 3.0 |

^{a}n-C16 was not detected

From C9 onwards, the hierarchical Pt/ZSM-23 started to favour the formation of isoparaffins over n-paraffins; this tendency was less pronounced with the parent Pt/ZSM-23 highlighting again the potential of the hierarchical ZSM-23 material for producing good quality aviation fuel or components thereto.

A further test run was made using a feedstock which was a blend of animal fat, UCO and vegetable oils. The feedstock was pre-treated to meet the impurity criteria (<10 w-ppm alkali metal and alkaline earth metals, <10 w-ppm other metals, <1000 w-ppm nitrogen containing impurities, <30 w-ppm phosphorus, <5 w-ppm silicon) before subjecting it to hydrodeoxygenation in a pilot reactor. HDO was carried out at a temperature of about 350° C., pressure of about 50 bars, WHSV about 1.2 h⁻¹, H₂ flow of about 600 N-L H₂/L feed, using a NiMo hydrodeoxygenation catalyst on an alumina support. The hydrodeoxygenated stream comprising C10 to C18 paraffins was directed to liquid-gas separation, and the obtained liquid phase was hydroisomerized using the 0.5 wt-% Pt impregnated hierarchical ZSM-23/Al₂O₃ supported catalyst, and the corresponding Pt-impregnated ZSM-23/Al₂O₃ supported parent catalyst. Both catalysts were passivated before isomerisation at 40 bar, WHSV 1.3 h⁻¹, H₂/oil ratio 300 N-L/L feed.

The branching analysis of the liquid products was made with an offline GC (QP2010 Ultra El, Shimadzu) having an FID detector and a mass spectrometer. The quality of the obtained liquid products were assessed with GC*GC analysis.

As the aviation fuel needs to meet the low cloud point requirements, the amount of higher end hydrocarbons, such as C18, needs to be low or they need to be well multibranched. It is known that compared to n-octadecane each attached methyl group decreases the melting point by about 15° C. The isomerisation was made aiming at the same cloud point for isomerized streams using the hierarchical ZSM-23 and the parent ZSM-23. Table 6 shows the multibranching tendencies for the higher end hydrocarbons using these catalysts.

TABLE 6
Amount of tri-methyl branching for the parent and the hierarchical
ZSM-23 for C15-18.

| Carbon | Tri-methyl branching | Tri-methyl branching |
|---|---|---|
| number | parent ZSM-23 | hierarchical ZSM-23 |
| 15 | 0.24 | 0.55 |
| 16 | 1.21 | 2.97 |
| 17 | 0.50 | 1.44 |
| 18 | 7.90 | 11.10 |
| total | 10.11 | 16.29 |

The hierarchical ZSM-23 clearly showed an enhanced tendency to produce tri-methyl branched carbon numbers for C15, C16, C17 and C18 hydrocarbons.

The specific examples provided in the description given above should not be construed as limiting the scope and/or the applicability of the appended claims.

Lists and groups of examples provided in the description given above are not exhaustive unless otherwise explicitly stated.

1. A method for producing renewable aviation fuel or components thereto from a renewable feedstock, the method comprising
a) providing the renewable feedstock,
b) pre-treating the renewable feedstock by reducing the amount of impurities therein not to include: more than 10 w-ppm alkali metal and alkaline earth metal impurities, calculated as elemental alkaline and alkaline earth metals; more than 10 w-ppm other metals, calculated as elemental metals; more than 1000 w-ppm nitrogen containing impurities, calculated as elemental nitrogen; more than 30 w-ppm phosphorus containing impurities, calculated as elemental phosphorus; more than 5 w-ppm silicon containing impurities, calculated as elemental silicon, to produce a pre-treated feedstock,
c) subjecting the pre-treated feedstock to hydrodeoxygenation reaction to produce a hydrodeoxygenated stream, wherein the hydrodeoxygenation reaction comprises one or more of:
a. a temperature in the range from 250° C. to 400° C.,
b. a pressure in the range from 10 bar to 200 bar,
c. a WHSV in the range from 0.5 h^{′1} to 3 h^{′1},
d. a H2 flow from 350 to 1500 N-L H2/L feed, and
e. a hydrodeoxygenation catalyst selected from Pd, Pt, Ni, Co, Mo, Ru, Rh, and W or any combination thereof, on a support to produce a hydrodeoxygenated stream,
d) subjecting the hydrodeoxygenated stream to a gas-liquid separation to produce a gaseous stream and a hydrodeoxygenated liquid stream, e) subjecting the hydrodeoxygenated liquid stream to hydroisomerization reaction conditions, in the presence of a metal impregnated hierarchical ZSM-23 catalyst, wherein the metal is selected from platinum, palladium, nickel and iridium, and any combinations thereof, at a temperature from 250° C. to 340° C., and in the presence of added hydrogen, to produce a hydroisomerized stream,
f) optionally subjecting the hydroisomerized stream to stabilization, to produce a stabilized hydroisomerized stream, and
g) separating the renewable aviation fuel or components thereto from the hydroisomerized stream, or from the stabilized hydroisomerized stream wherein the renewable aviation fuel or components thereto comprises C5-C9 hydrocarbons suitable for aviation gasoline or components thereto, and C10-C18 hydrocarbons, preferably C10-C16 hydrocarbons suitable for jet fuel or components thereto.

2. The method according to claim 1, wherein the step g) further comprises separating a fraction rich in renewable C1-C4 hydrocarbons from the hydroisomerized stream, or from the stabilized hydroisomerized stream.

3. The method according to claim 1, wherein in step c) temperature is from 260° C. to 380° C., preferably from 280° C. to 360° C., such as from 300° C. to 330° C. pressure is from 20 bar to 100 bar, preferably from 20 bar to 80 bar, a weight hourly space velocity (WHSV) is in the range from 0.5 h⁻¹ to 3.0 h^{′1}, preferably from 0.7 h^{′1} to 2.5 h^{′1}, most preferably from 1.0 h^{′1} to 2.0 h^{′1} and H2 flow is in the range from 350 to 1100 N-L H2/L feed, preferably from 350 to 1000 N-L H2/L feed.

4. The method according to claim 1, wherein the hierarchical ZSM-23 has one or more of the following features:
i. volume of micropores is more than 0.03 mL/g, preferably more than 0.06 mL/g,
ii. volume of mesopores is more than 0.25 mL/g, preferably more than 0.60 mL/g,
ii. ratio of Bronsted acid sites to the Lewis acid sites is more than 15, preferably more than 20, as determined by pyridine FT-IR,
iv. SiO2/Al2Os molar ratio is from 45 to 90, preferably from 55 to 80, more preferably from 60 to 70, and
v. crystallinity is less than 60%, preferably less than 50% as measured by XRD according to ASTM D5758-01 (2021).

5. The method according to claim 1, wherein the metal impregnated hierarchical ZSM-23 catalyst further comprises a support, wherein the support is preferably alumina and/or silica.

6. The method according to claim 1, wherein the gas liquid separation of step d) further comprises separating C17 and higher hydrocarbons from the hydrodeoxygenated stream.

7. The method according to claim 1, wherein the hydroisomerization reaction comprises a temperature in the range from 270° C. to 290° C.

8. The method according to claim 1, wherein pressure of the hydrogen in step e) is 10-50 bar.

9. The method according to claim 1, wherein the hydrodeoxygenation catalyst is selected from a group consisting of CoMo, NiMo, NiW, and CoNiMo on a support, wherein the support is preferably alumina and/or silica.

10. The method according to claim 1, wherein the hydrodeoxygenation reaction comprises temperature in the range from 250° C. to 400° C., pressure in the range from 20 bar to 80 bar, a WHSV in the range from 0.5 h⁻¹ to 3 h^{′1}, and H2 flow of 350-1500 N-L H2/L feed, and a hydrodeoxygenation catalyst.

11. The method according to claim 1, wherein the hydrodeoxygenated stream comprises at least 92 wt-%, preferably at least 95 wt-%, more preferably at least 99 wt-% paraffins based on total weight of hydrocarbon products.

12. The method according to claim 1, wherein the renewable aviation fuel of components thereto comprises at least 95 wt-%, preferably at least 97 wt-% i-paraffins.

13. The method according to claim 1, wherein C16 hydrocarbons of the renewable aviation fuel comprise at least 70 wt-% multibranched C16 hydrocarbons.

14. The method according to claim 1, wherein the feedstock is selected from waste and residues of animal fat or oil, plant fat or oil, and fish fat or oil, and mixtures thereof, preferably the feedstock is selected from palm oil residues and wastes, such as palm effluent sludge, palm oil mill effluent, sludge palm oil, palm oil fatty acid; tall oil material; used cooking oil; acid oils; animal fats, such as brown grease; spent bleaching earth oil; and technical corn oil.

15. The method according to claim 1, wherein the feedstock comprises triglycerides.

16. Use of a metal impregnated hierarchical ZSM-23 catalyst, wherein the metal is selected from platinum, palladium, nickel and iridium, and any combinations thereof for producing renewable aviation fuel or components thereto from a renewable paraffinic feed by hydroisomerization at a temperature from 250° C. to 340° C., and in the presence of added hydrogen flow.

17. The use according to claim 16, wherein the hierarchical ZSM-23 has one or more of the following features:
i. volume of micropores is more than 0.03 mL/g, preferably more than 0.06 mL/g
ii. volume of mesopores is more than 0.25 mL/g, preferably more than 0.60 mL/g
iii. ratio of Bronsted acid sites to the Lewis acid sites is more than 15, preferably more than 20 as determined by pyridine FT-IR,
iv. SiO2/Al2Os molar ratio is from 45 to 90, preferably from 55 to 80, more preferably from 60 to 70, and
v. crystallinity is less than 60%, preferably less than 50% as measured by XRD according to ASTM D5758-01 (2021).

18. The use according to claim 16, wherein the metal impregnated hierarchical ZSM-23 catalyst further comprises a support, wherein the support is preferably alumina and/or silica.
